(19) United States
(12) Patent Application Publication
(10) Pub. No.: US 2010/0058909 A1
(43) Pub. Date: Mar. 11, 2010

(54) Power tool

(76) Inventor: Shaodong Chen, Suzhou (CN)

Correspondence Address: PATE PIERCE & BAIRD, 175 SOUTH MAIN STREET, SUITE 1250, SALT LAKE CITY, UT, 84111, US

(21) Appl. No.: 12/283,433

(22) Filed: Sep. 11, 2008

(51) Int. Cl. B23D 45/14; B27B 5/20

(52) U.S. Cl. 83/471.3; 83/473; 83/477.2; 83/490

(57) ABSTRACT

The present invention relates to a miter saw which includes a turntable, an elongate coupling mechanism pivotally mounted with respect to the turntable about a bevel axis to adjust to a bevel angle and a saw unit pivotally connected to the elongate coupling mechanism for movement between a non-cutting position and a cutting position. An angle enlarging mechanism is disposed between the turntable and the elongate coupling mechanism which is used for conveniently reading the bevel angle.

### BACKGROUND OF THE INVENTION

1. Field of the Invention

The present invention relates to a power tool (in particular to a miter saw) having an angle enlarging mechanism.

2. The Related Arts

A conventional miter saw generally includes a saw unit supported on a turntable for movement between a raised (non-cutting) position and a lowered (cutting) position. The turntable may be movably coupled to a base about a substantially vertical axis. To adjust the miter angle of the saw unit, a user unlocks the turntable from the base, rotates the turntable relative to the base about the vertical axis to a desired miter angle and locks the turntable to the base. The saw unit may be movably coupled to the turntable by a support mechanism about a substantially horizontal axis. To adjust the bevel angle of the saw unit, the user unlocks the saw unit from the turntable, rotates the saw unit relative to the turntable about the bevel axis to a desired bevel angle and locks the saw unit to the turntable.

A bevel indicator is mounted between the support mechanism and the turntable for measuring the bevel angle. The bevel indicator includes a scale with markings mounted on one of the support mechanism and the turntable and a pointer mounted on the other of the support mechanism and the turntable. As the support mechanism is rotated through 45-degrees (single bevel version) or 90-degrees (dual bevel version), the pointer on the scale is moved through an identical amount of angular rotation. The tilt may be set at gradations with 5-degree or 1-degree increments and may have infinite adjustability within a set angular range. However the size of the scale will be limited by the structure of the supporting arm and the turntable so markings on the scale may be close to one another which makes it difficult to read the tilt angle accurately.

In US2008/0060495 there is disclosed a tiltable miter saw having a front bevel indicator and a scale magnifier for measuring the bevel. In U.S. Pat. No. 6,397,716 there is disclosed a gearing mechanism coupling a workpiece support and the pivot support to a dial to indicate the angle between the surface of the workpiece and the plane of the saw blade.

### SUMMARY OF THE INVENTION

An object of the present invention is to provide a power tool in which the tilt angle is easily and accurately read.

Accordingly the present invention provides a power tool comprising: a stationary member, a tiltable member pivotally mounted on the stationary member about a horizontal axis, an angle enlarging mechanism disposed between the stationary member and the tiltable member. The angle enlarging mechanism includes: a fixed gear fixed on one of the stationary member and the tiltable member, a transmission assembly disposed on the other of the stationary member and the tiltable member and a rotary gear having internal teeth. The rotary gear is movably supported on one of the stationary member and the tiltable member. The transmission assembly includes a first gear for meshing with the fixed gear and a second gear for meshing with the internal teeth of the rotary gear. An indicator assembly comprises an indicator disposed immovably with one of the rotary gear and the stationary member.

In an embodiment, the power tool comprises:

a cutting table for supporting a cuttable workpiece, wherein the cutting table is in a working plane;
a cutting unit including a cutting tool, wherein the cutting unit is rotational about a bevel axis whereby to adjust the cutting tool from a first plane relative to the working plane defining a first bevel angle to a second plane relative to the working plane defining a second bevel angle, wherein the cutting unit is pivotal from an elevated non-cutting position remote from the cutting table to a non-elevated cutting position at or near to the cutting table and from the non-elevated cutting position at or near to the cutting table to the elevated non-cutting position remote from the cutting table;
an elongate coupling assembly operatively coupling the cutting unit to the cutting table which is adapted to rotate the cutting unit about the bevel axis to adjust the cutting tool from the first plane to the second plane and to pivot the cutting unit from the elevated non-cutting position to the non-elevated cutting position;
a stationary member fixed to the cutting table;
a tiltable member fixed to the elongate cutting assembly so as to be pivotal relative to the stationary member in response to the rotation of the cutting unit about the bevel axis; and
an angle enlarging mechanism disposed between the stationary member and the tiltable member, wherein the angle enlarging mechanism includes:
a fixed gear fixed on one of the stationary member and the tiltable member
a transmission assembly disposed on the other of the stationary member and the tiltable member
a rotary gear having internal teeth, wherein the rotary gear is movably supported on the one or the other of the stationary member and the tiltable member, wherein the transmission assembly includes a first gear for meshing with the fixed gear and a second gear for meshing with the internal teeth of the rotary gear and
an indicator assembly including an indicator for indicating the bevel angle disposed immovably on one of the rotary gear and the stationary member.

The bevel axis may be defined by a bevel shaft fixed to the cutting table on which is rotatably mounted the elongate coupling assembly. The bevel axis may be defined by a bevel shaft fixed to the elongate coupling assembly on which is rotatably mounted the cutting table.

The indicator may be a pointer arrow or a scale line.

In a resting position, the cutting tool is typically in a first plane substantially perpendicular to the working plane. The elongate coupling assembly may be adapted to rotate the cutting unit through 0-45 degrees or 0-90 degrees.

The cutting unit is typically biassed into the elevated non-cutting position.

The first gear may be a pinion. The second gear may be a gearwheel.

Preferably the bevel axis is substantially radial to the cutting table. Preferably the bevel axis is substantially horizontal. Preferably the axis of the transmission assembly is non-coincident with the bevel axis so as to rotate the rotary gear when the tiltable member pivots relative to the stationary member.

Preferably when the tiltable member pivots relative to the stationary member, the transmission assembly is actuated around the bevel axis so as to cause the first gear to rotate the fixed gear and the second gear to rotate the rotary gear.

Preferably when the tiltable member pivots relative to the stationary member, the fixed gear is actuated around the bevel axis to rotate the first gear and to cause the second gear to rotate the rotary gear.

Preferably the indicator assembly further includes: a scale disposed immovably on the other of the rotary gear and the stationary member.

The first gear may be fixed to or integral with the second gear. Preferably in use the first gear turns the fixed gear in an opposite rotating direction and the second gear turns the rotary gear in a same rotating direction.

The first gear (eg pinion) may extend substantially axially from the second gear (eg gearwheel).

Preferably the transmission assembly further includes: a short shaft, wherein the first gear and the second gear are rotatably mounted on the short shaft. Particularly preferably the short shaft is fixed to the one or the other of the stationary member and the tiltable member.

Preferably the fixed gear is fixed to the tiltable member, the transmission assembly is fixed to the stationary member and the rotary gear is movably supported on the stationary member. Particularly preferably in use the rotational direction of the rotary gear differs from the rotational direction of the tiltable member.

Preferably the fixed gear is fixed to the stationary member, the transmission assembly is fixed to the tiltable member and the rotary gear is movably supported on the tiltable member. Particularly preferably in use the rotational direction of the rotary gear and the rotational direction of the tiltable member are the same.

Preferably the diameter of the rotary gear is greater than the diameter of the second gear. Preferably the diameter of the fixed gear is greater than the diameter of the first gear. Preferably the diameter of the second gear is greater than the diameter of the first gear.

In a preferred embodiment the power tool is a miter saw. Preferably the miter saw comprises: a base, wherein the cutting table is a turntable pivotally mounted on the base. Preferably the cutting unit includes a motor and the cutting tool is a rotary saw blade driven by the motor.

Preferably the elongate coupling assembly includes:

a first support mechanism mounted on the turntable rotationally about the substantially radial bevel axis
a second support mechanism, wherein the cutting unit is pivotally mounted on the second support mechanism for flexion of the rotary saw blade from the elevated non-cutting position to the non-elevated cutting position and extension of the rotary saw blade from the non-elevated cutting position to the elevated non-cutting position and
an elongate linkage arrangement linking the first support mechanism to the second support mechanism, wherein the tiltable member is fixed to the first support mechanism.

The bevel axis may be defined by a bevel shaft fixed to the turntable on which is rotatably mounted the first support mechanism.

Preferably the elongate linkage arrangement includes a first elongate link arm pivotally disposed between the first support mechanism and the second support mechanism and a second elongate linkage arm pivotally disposed between the first support mechanism and the second support mechanism.

Preferably the power tool further comprises:

a damper device disposed between the first elongate link arm and second elongate link arm, the damper device including: a cylinder defining a compression chamber pivotally connected to the second elongate link arm, a piston for rectilinearly reciprocating in the compression chamber so as to compress air, a shaft interconnected to the piston which is pivotally connected to the first elongate link arm, a first cap disposed on a first end of the cylinder and a second cap disposed on a second end of the cylinder.

The damper device may comprise a tension spring or cylinder.

Preferably the damper device further includes: a first windpipe connected to the first cap and a second windpipe connected to the second cap. Preferably the first windpipe and second windpipe are flexible tubes receivable in a gap in the second elongate link arm or the first elongate link arm.

Preferably the power tool further comprises: a laser indication device mounted on the first elongate link arm which includes: a laser generator, a laser seat for supporting the laser generator and a support seat attached to the first elongate link arm for supporting the laser seat. Preferably one of the first windpipe and the second windpipe extends through the first elongate link arm to be opposite to the laser generator.

In a preferred embodiment, the power tool comprises:

a stationary member;
a tiltable member pivotally mounted on the stationary member about a horizontal axis;
an angle enlarging mechanism disposed between the stationary member and the tiltable member, the angle enlarging mechanism including:
a fixed gear fixedly disposed on one of the stationary member and the tiltable member;
a transmission assembly disposed on the other of the stationary member and the tiltable member;
a rotatable gear having internal teeth, the rotatable gear movably supported on one of the stationary member and the tiltable member;
wherein the transmission assembly includes a first gear for meshing with the fixed gear and a second gear for meshing with the internal teeth of the rotary gear;
an indicator assembly comprising an indicator disposed immovably with one of the rotatable gear and the stationary member.

### BRIEF DESCRIPTION OF THE DRAWINGS

The advantages of the present invention will be better understood by those skilled in the art by reference to the description of preferred embodiments and the accompanying figures in which:

FIG. 1 illustrates a perspective view of an embodiment of the power tool of the present invention in the form of a miter saw;

FIG. 2 illustrates a partial section view of the miter saw in a resting position;

FIG. 3 illustrates a partial section view of the miter saw in a cutting position;

FIG. 4 illustrates a partial section view of the miter saw in a cutting position when the saw blade contacts the workpiece (not shown);

FIG. 5 illustrates a partial section view of the miter saw when the saw blade has cut the workpiece (not shown);

FIG. 6 illustrates a cross-sectional view taken along line A-A in FIG. 2;

FIG. 7 illustrates a cross-sectional view taken along line B-B in FIG. 2;

FIG. 8 illustrates a partial enlarged view of the angle enlarging mechanism in FIG. 2;

FIG. 9 illustrates a cross-sectional view taken along line C-C in FIG. 9;

FIG. 10 illustrates a cross-sectional view taken along line D-D in FIG. 9;

FIG. 11a illustrates a partial section view of an angle enlarging mechanism according to a second embodiment of the invention;

FIG. 11b illustrates an isolated view of the transmission assembly in the second embodiment of the invention shown in FIG. 11a;

FIG. 12 illustrates a cross-sectional view taken along line H-H in FIG. 11a;

FIG. 13 illustrates a section view of the damper device of the miter saw of the invention;

FIG. 14 illustrates an enlarged view according to the indicator A in FIG. 13;

FIG. 15 illustrates an enlarged view according to the indicator B in FIG. 13;

FIG. 16 illustrates a perspective view of a laser indication device of the miter saw of the invention;

FIG. 17 illustrates a section view taken along line G-G in FIG. 2;

FIG. 18 illustrates a side view of the miter saw, wherein the second windpipe is in the second position; and

FIG. 19 illustrates a rear view of the miter saw illustrated in FIG. 1.

### DETAILED DESCRIPTION OF THE PREFERRED EMBODIMENTS

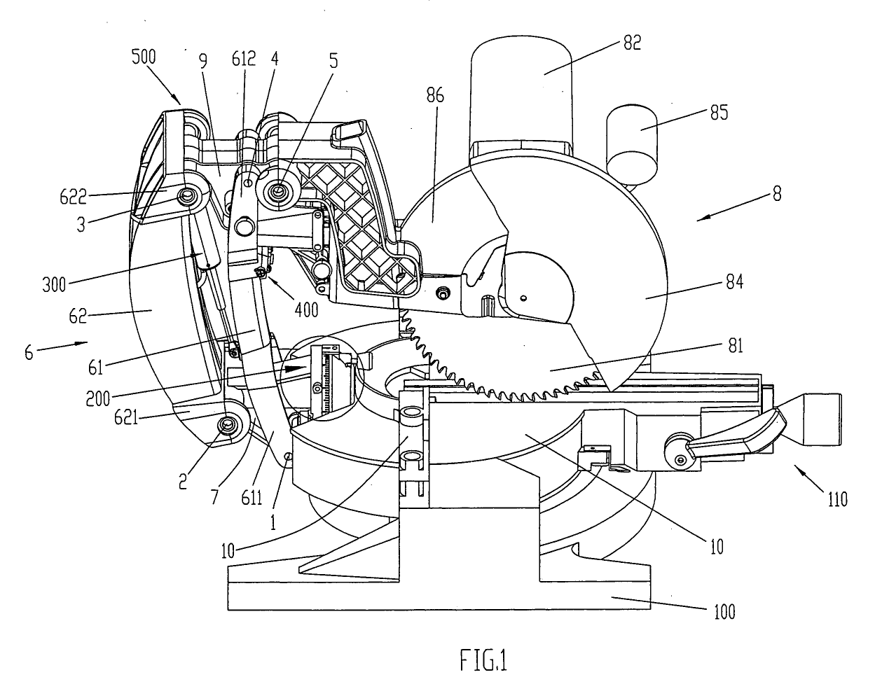

As shown in FIG. 1, a first embodiment of the miter saw of the invention comprises a substantially circular base 100 to which is fixed a fence 101. A rotary turntable 10 is pivotally mounted axially on the base 100 and provides a support surface for supporting a workpiece. A miter arm control assembly 110 is capable of adjusting the rotational position of the turntable 10 relative to the base 100 to set the miter angle of a workpiece supported on the support surface.

A saw unit 8 has an electric motor 82 which is operatively connected to a transmission mechanism to drive a rotary saw blade 81. The rotary saw blade 81 is normally in a plane substantially perpendicular to the plane of the turntable 10. A handle 85 fixed laterally to the saw unit 8 enables an operator to pivot the saw unit 8 into and out of engagement with a workpiece supported on the support surface adjacent to the fence 101.

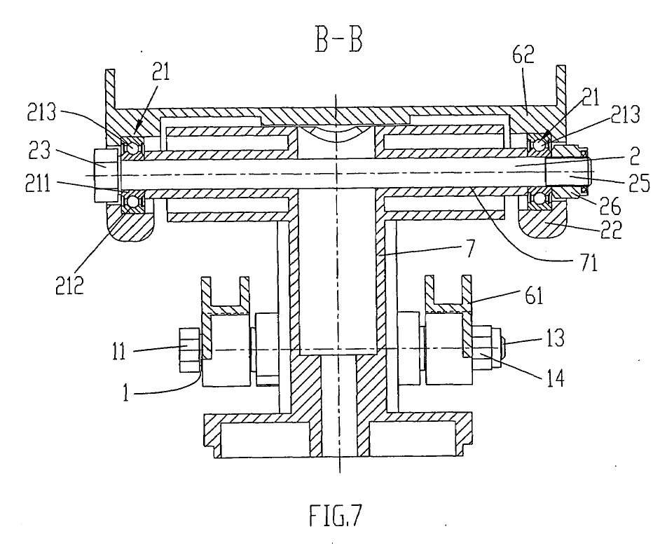

The saw unit 8 is operatively coupled to the turntable 10 by an elongate coupling assembly 500. The elongate coupling assembly 500 includes a first support mechanism 7 at a lower end and a second support mechanism 9 at an upper end. The first support mechanism 7 is linked to the second support mechanism 9 by an elongate linkage arrangement 6. The saw unit 8 is pivotally mounted on the second support mechanism 9 for flexion of the rotary saw blade 81 from an elevated non-cutting position remote from the turntable 10 to a non-elevated cutting position at or near to the turntable 10 (and extension of the rotary saw blade 81 from the non-elevated cutting position at or near to the turntable 10 to the elevated non-cutting position remote from the turntable 10). The first support mechanism 7 is mounted on the turntable 10 rotationally about a substantially radial bevel axis 102 (see FIGS. 9, 10 and 11b) defined by a bevel shaft 102a to adjust the saw unit 8 to a bevel angle relative to the base 100. The elongate linkage arrangement 6 pivots or tilts in unison with the first support mechanism 7.

The first support mechanism 7 has a first substantially horizontal shaft 1 disposed substantially tangentially to the turntable 10 and a second substantially horizontal shaft 2 which is spaced apart and substantially parallel to the first substantially horizontal shaft 1. The second support mechanism 9 has a third substantially horizontal shaft 3, a fourth substantially horizontal shaft 4 and a fifth substantially horizontal shaft 5 which are substantially parallel and spaced apart. The saw unit 8 is pivotally mounted on the fifth horizontal shaft 5. The fifth horizontal shaft 5 is parallel and non-coaxial with the third and the fourth horizontal shafts 3 and 4 and provides an independent fulcrum to permit the saw unit 8 to extend out of contact with a workpiece or flex into contact with the workpiece during a cutting operation.

The elongate linkage arrangement 6 includes a first elongate link arm 61 and a second elongate link arm 62 which are substantially parallel and spaced apart. A first end 611 of the first elongate link arm 61 is coupled to the first support mechanism 7 by the first horizontal shaft 1. A first end 621 of the second elongate link arm 62 is coupled to the first support mechanism 7 by the second horizontal shaft 2. The second end 612 of the first elongate link arm 61 is coupled to the second support mechanism 9 by the fourth horizontal shaft 4. The second end 622 of the second elongate link arm 62 is coupled to the second support mechanism 9 by the third horizontal shaft 3.

The width of the second elongate link arm 62 is larger than the width of the first elongate link arm 61 to permit the saw unit 8 to move towards and away from the fence 101. The first elongate link arm 61 is longer than the second elongate link arm 62 to maintain the elevation of the saw unit 8 during movement of the saw unit 8 towards and away from the fence 101. The first elongate link arm 61 is mounted near to the turntable 10 and the miter saw has a dual bevel operation.

As shown in FIG. 19, the second elongate link arm 62 is an open structure and has first and second side walls 617 and an end wall 619 with cross braces 618 to increase strength. The second elongate link arm 61 is constructed similarly.

The saw unit 8 includes a blade case 86 pivotally mounted on the second support mechanism 9 and partly covering the saw blade 81 to expose an operational portion of the saw blade 81. A safety cover 84 is pivotally mounted on the blade case 86 for covering the operational portion of the saw blade 81. A safety actuating mechanism 83 is disposed between the second support mechanism 9 and the safety cover 84 for quickly actuating the safety cover 84 to pivot to uncover the operational portion of the saw blade 81.

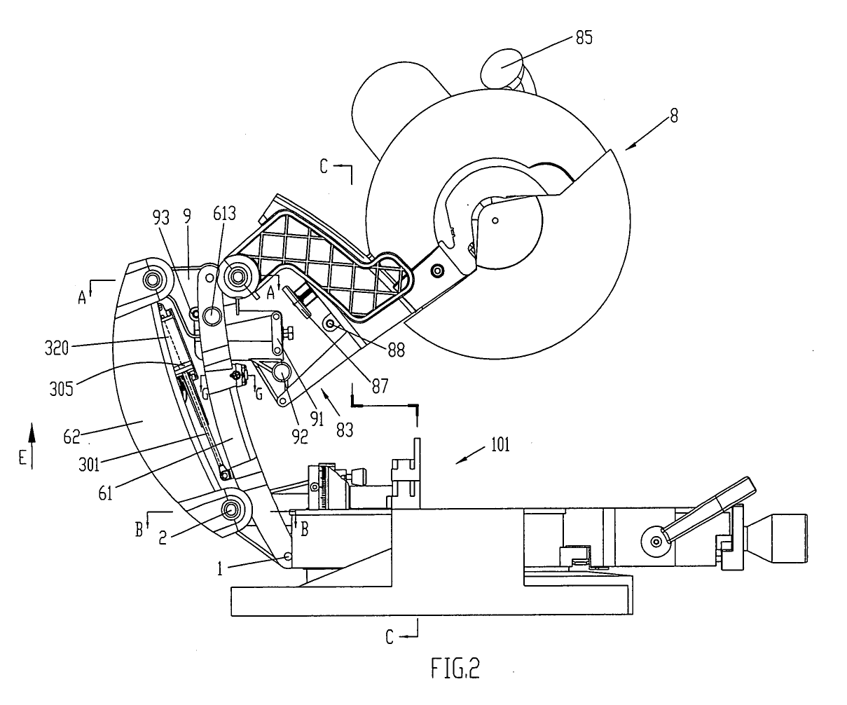

A compression spring (not shown) extends between support portions 91, 87 formed on the second support mechanism 9 and the saw unit 8 respectively (see FIG. 2). The compression spring is spaced apart from the fulcrum of the pivotal movement of the saw unit 8 and is elastically extensible in its longitudinal direction so as to normally urge the saw unit 8 away from the base 100.

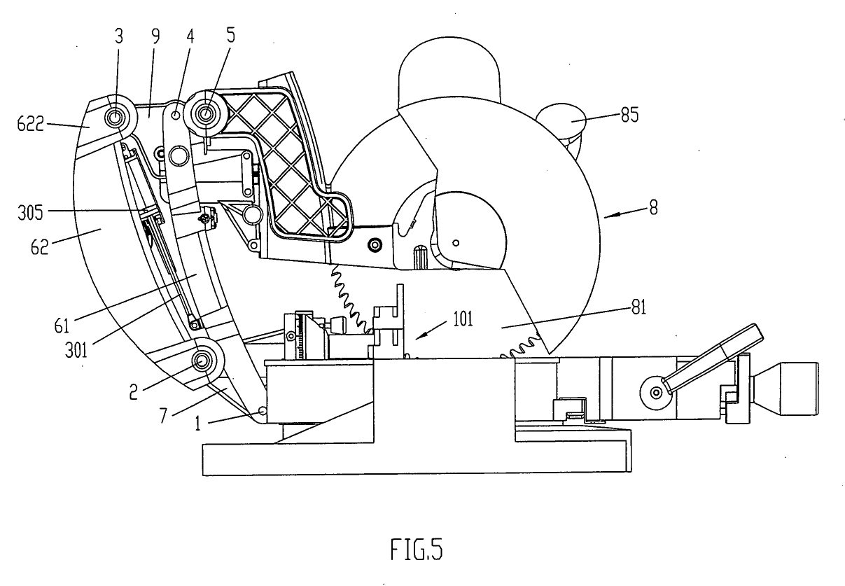

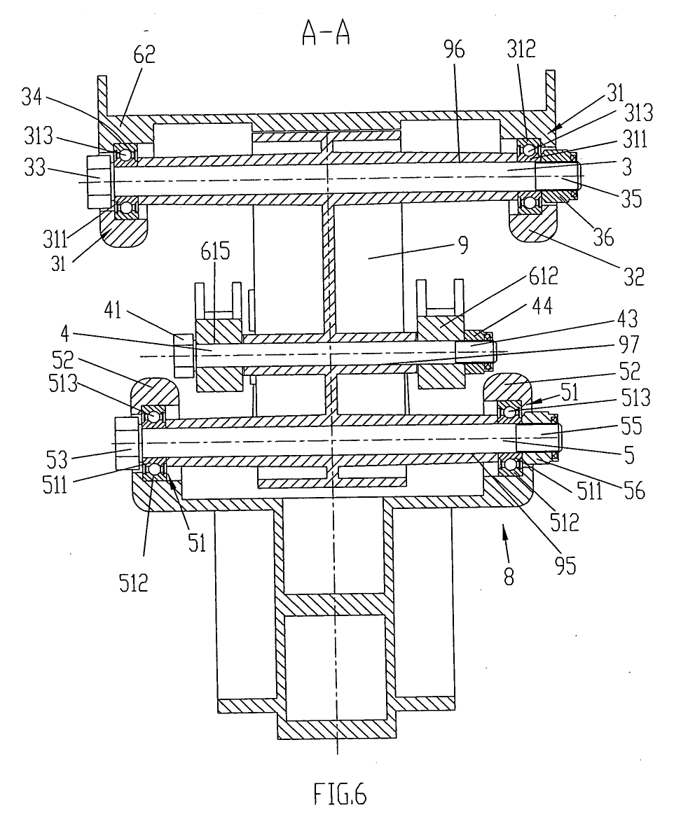

As shown in FIG. 6, the fifth horizontal shaft 5 has a first end portion 53 and a second end portion 55 which is threaded. The fifth horizontal shaft 5 passes through a bore 95 which is formed in the saw unit 8. Each of the first end portion 53 and second end portion 55 bear respectively against an inner race 511 of a pair of ball bearings 51. Each ball bearing 51 also has an outer race 512 and a plurality of balls 513. A nut 56 is threaded on the second end portion 55 of the fifth horizontal shaft 5 and is tightened so as to urge the ball bearings 51 towards one another and offsets the ball bearings 51 relative to one another in the longitudinal direction. To offset the ball bearings 51 radially relative to the fifth horizontal shaft 5, the miter saw further includes a pair of fifth bearing offset mechanisms. The fifth bearing offset mechanisms are symmetrically disposed relative to the plane of the saw blade 81. Each of the fifth bearing mechanisms includes a bearing cap 52 attached to the saw unit 8, a fifth aperture formed by the saw unit 8 and the bearing cap 52 for receiving the ball bearings 51 and a locking mechanism for connecting the saw unit 8 and the bearing cap 52. The locking mechanism is a screw which is tightened to pull the bearing cap 52 towards the saw unit 8 and offset each ball bearing 51 in the radial direction. The ball bearings 51 and the fifth bearing offset mechanisms accommodate play or looseness in the ball bearing 51 which would otherwise contribute to deterioration in the quality of the cut.

Similarly as shown in FIG. 6, the third horizontal shaft 3 extends longitudinally and has a first end portion 33 and a second end portion 35 which is threaded. The third horizontal shaft 3 passes through a bore 96 which is formed in the second support mechanism 9. Each of the first end portion 33 and the second end portion 35 bear respectively against an inner race 311 of a pair of ball bearings 31. Each ball bearing 31 also has an outer race 312 and a plurality of balls 313. A nut 36 is threaded on the second end portion 35 of the third horizontal shaft 3 and is tightened so as to pull the ball bearings 31 towards one another and offsets the ball bearings 31 relative to one another in the longitudinal direction. To offset the ball bearings 31 radially relative to the third horizontal shaft 3, the miter saw further includes a pair of third bearing offset mechanisms. Each of the third bearing offset mechanisms includes a bearing cap 32 attached to the second elongate link arm 62, a third aperture formed by the second end 622 of the second elongate link arm 62 and the bearing cap 32 for receiving the ball bearings 31 and a locking mechanism for connecting the second elongate link arm 62 and the bearing cap 32. The locking mechanism are screws which are tightened so as to pull the bearing cap 32 towards the second elongate link arm 62 and offsets each ball bearing 31 in the radial direction. The ball bearings 31 and the third bearing offset mechanisms accommodate play or looseness in the ball bearing 31 which would otherwise contribute to deterioration in the quality of the cut.

Similarly as shown in FIG. 7, the second horizontal shaft 2 extends longitudinally and has a first end portion 23 and a second end portion 25 which is threaded. The second horizontal shaft 2 passes through a bore 71 which is formed in the first support mechanism 7. Each of the first end portion 23 and the second end portion 25 bear respectively against an inner race 211 of a pair of ball bearings 21. Each ball bearing 21 also has an outer race 212 and a plurality of balls 213. A nut 26 is threaded on the second end portion 25 of the second horizontal shaft 2 and is tightened so as to pull the ball bearings 21 towards one another and offsets the ball bearings 21 relative to one another in the longitudinal direction. To offset the ball bearings 21 radially relative to the second horizontal shaft 2, the miter saw further includes a pair of second bearing offset mechanisms. Each of the second bearing offset mechanisms includes a bearing cap 22 attached to the second elongate link arm 62, a second aperture formed by the first end 621 of the second elongate link arm 62 and the bearing cap 32 for receiving the ball bearings 21 and a locking mechanism for connecting the second elongate link arm 62 and the bearing cap 22. The locking mechanism are screws which are tightened so as to pull the bearing cap 22 towards the second elongate link arm 62 and offsets each ball bearing 21 in the radial direction. The ball bearings 21 and the second bearing offset mechanisms accommodate play or looseness in the ball bearing 21 which would otherwise contribute to deterioration of the quality of the cut.

The function of the first elongate link arm 61 is to maintain the elevation of the saw unit 8 during movement of the saw unit 8 towards and away from the fence 101. For this reason, the pivotal connections of the first elongate link arm 61 to the first and second support mechanism 7 and 9 are as follows.

As shown in FIG. 7, the first horizontal shaft 1 extends longitudinally and has a first end portion 11 and a second end portion 13 which is threaded. The first horizontal shaft 1 passes through a bore formed in the first support mechanism 7 and a bore formed on the second end 612 of the first elongate link arm 61. A nut 14 is threaded on the second end portion 13 of the first horizontal shaft 1 and is tightened so as to offset the first horizontal shaft 1 in the longitudinal direction.

Similarly as shown in FIG. 6, the fourth horizontal shaft 4 extends longitudinally and has a first end portion 41 and a second end portion 43 which is threaded. The fourth horizontal shaft 4 passes through a bore formed on the second support mechanism 9 and a bore formed on the first end 611 of the first elongate link arm 61. A nut 44 is threaded on the second end portion 43 of the fourth horizontal shaft 4 and is tightened so as to offset the fourth horizontal shaft 4 in the longitudinal direction.

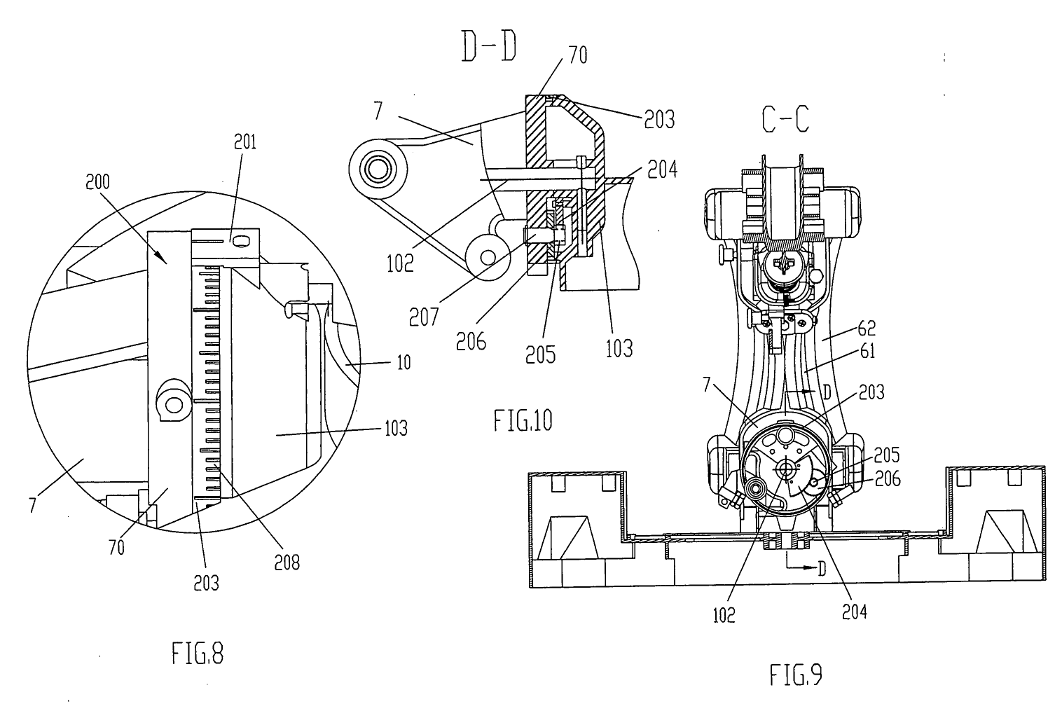

As shown in FIG. 8, a stationary member 103 is fixed to the turntable 10. A tiltable member 70 is fixed to the first support mechanism 7. The tiltable member 70 is mounted relative to the stationary member 103 about the substantially radial bevel axis 102 (as shown in FIGS. 9 and 10). The miter saw further includes an angle enlarging mechanism 200 disposed between the stationary member 103 and the tiltable member 70.

The angle enlarging mechanism 200 of the first preferred embodiment shown in FIGS. 8 to 10 includes a fixed gear 204 fixed to the stationary member 103, a transmission assembly attached to the tiltable member 70 and a rotary gear 203 which is movably supported on the tiltable member 70 and moves relative to the tiltable member 70. The rotary gear 203 is an internal meshing gear which includes internal teeth 209 on the inner periphery.

The transmission assembly includes a gearwheel 206 for meshing with the internal teeth 209 of the rotary gear 203, a pinion 205 fixed to the gearwheel 206 for meshing with the fixed gear 204 and a short shaft 207 fixed to the tiltable member 70. The pinion 205 and the gearwheel 206 are rotatably mounted on the short shaft 207. The pinion 205, the gearwheel 206 and the short shaft 207 are housed between the stationary member 103 and the tiltable member 70. The diameter of the gearwheel 206 is greater than that of the pinion 205. The diameter of the rotary gear 203 is greater than that of the gearwheel 206. The diameter of the fixed gear 204 is greater than that of the pinion 205.

The external teeth of the pinion 205 are meshed with the external teeth of the fixed gear 204. The pinion 205 turns the fixed gear 204 in an opposite rotating direction. The internal teeth 209 of the rotary gear 203 are meshed with the external teeth of the gearwheel 206. The gearwheel 206 turns the rotary gear 203 in the same rotating direction.

The fixed gear 204 is disposed coaxially relative to the substantially radial bevel axis 102. The tiltable member 70 rotates through only 90-degrees in the dual bevel version. The fixed gear 204 is designed as a fan-shaped gear or a gear which is quarter round.

As the saw unit 8 is rotated, the short shaft 207 attached to the tiltable member 70 is actuated around the bevel axis 102. In the mean time, the pinion 205 rotates the fixed gear 204 in an opposite direction. The gearwheel 206 rotates the rotary gear 203 in the same direction. The rotational direction of the pinion 205 corresponds to the rotational direction of the gearwheel 206. Thus the rotational direction of the rotary gear 203 corresponds to the rotational direction of the saw unit 8 to provide the user with an intuitive sense in positioning the saw blade.

The angle enlarging mechanism 200 further includes an indicator assembly for indicating the bevel angle which comprises an indicator in the form of a scale line 201 disposed immovably on the stationary member 103 and a scale with markings disposed immovably on the outer periphery of the rotary gear 203.

The rotary gear 203 is used as a scale magnifier. Scaling is achieved through judicious selection of gear ratios. The fixed gear 204 and pinion 205 and the gearwheel 206 and the rotary gear 203 are respectively scaled so that the motion of the saw unit 8 is magnified appropriately in the motion of the rotary gear 203 to provide a higher resolution to the user. When the saw unit 8 is rotated along with the tiltable member 70, the rotation of the tiltable member 70 is translated and amplified through the fixed gear 204 to the rotary gear 203. For example, when the tiltable member 70 rotates through 45 degrees, the rotary gear 203 rotates through about 90 degrees (2× amplification) whilst markings on the outer periphery of the rotary gear 203 show the true bevel angle (ie through 45 degrees). Amplification values such as 3 and 5 may be achieved with the present invention to permit straightforward and accurate reading of the bevel angle.

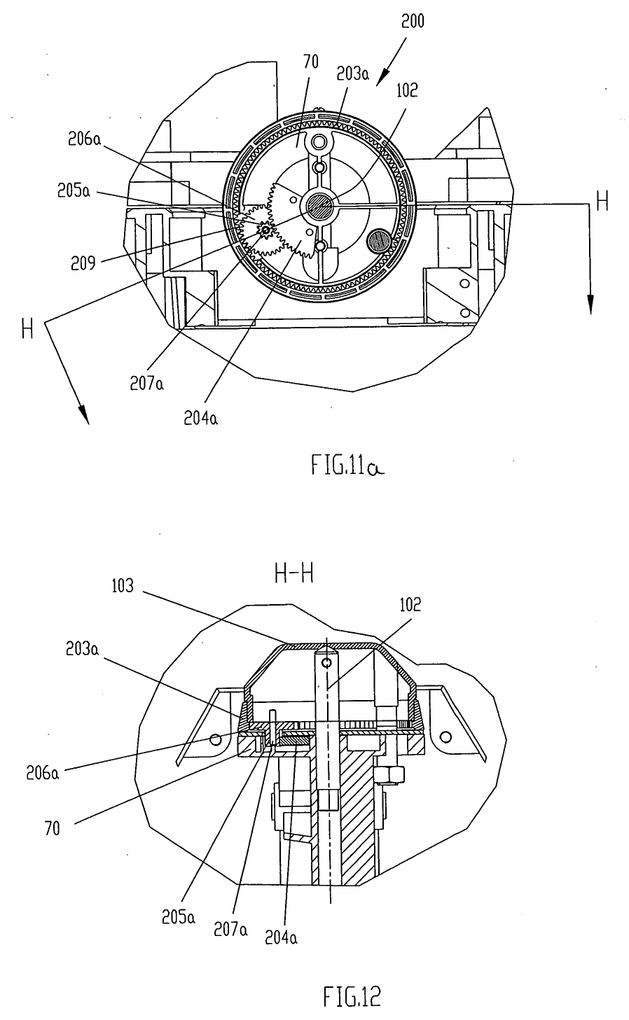

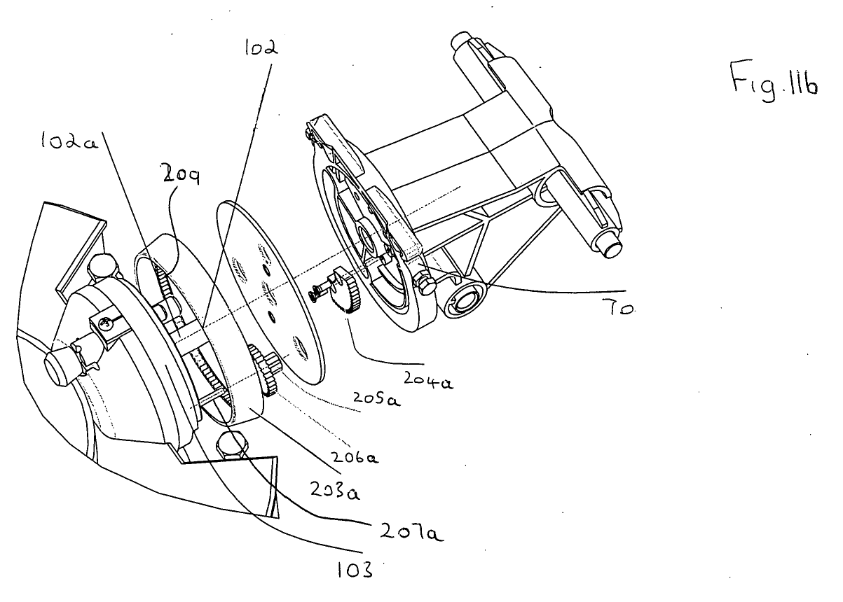

An alternative angle enlarging mechanism 200a is shown in a second embodiment of the present invention in FIGS. 11 and 12. Many of the components are similar to the first embodiment of the angle enlarging mechanism 200 described above. In the following description, components that are labeled with the same numbers as those shown and described with regard to the first embodiment are substantially similar in their design, configuration and operation and therefore will not be described in detail.

The angle enlarging mechanism 200a includes a fixed gear 204a fixed to the tiltable member 70, a transmission assembly attached to the stationary member 103 and a rotary gear 203a movably supported on the stationary member 103.

The transmission assembly is substantially similar to the transmission assembly of the first embodiment. The transmission assembly includes a gearwheel 206a for meshing with the internal teeth 209 of the rotary gear 203a, a pinion 205a for meshing with the fixed gear 204a and a short shaft 207a fixed to the stationary member 103 on which is mounted the gearwheel 206a and pinion 205a.

The rotary gear 203a is used as a scale magnifier. Scaling is achieved through judicious selection of gear ratios. The fixed gear 204a and pinion 205a and the gearwheel 206a and the rotary gear 203a are respectively scaled so that the motion of the saw unit 8 is magnified appropriately in the motion of the rotary gear 203a to provide a higher resolution to the user. When the saw unit 8 (not shown) is rotated, the fixed gear 204a attached to the tiltable member 70 is actuated around the substantially radial bevel axis 102. In the mean time, the fixed gear 204a rotates the pinion 205a in an opposite direction. The gearwheel 206a rotates the rotary gear 203a in the same direction. The rotational direction of the pinion 205a corresponds to the rotational direction of the gearwheel 206a. Thus the rotational direction of the rotary gear 203a differs from the rotational direction of the saw unit 8.

As shown in FIG. 1, the miter saw of this invention is equipped with a damper device 300. The damper device 300 is disposed between the first elongate link arm 61 and the second elongate link arm 62 for reducing the impact force of the elongate linkage arrangement 6 during movement.

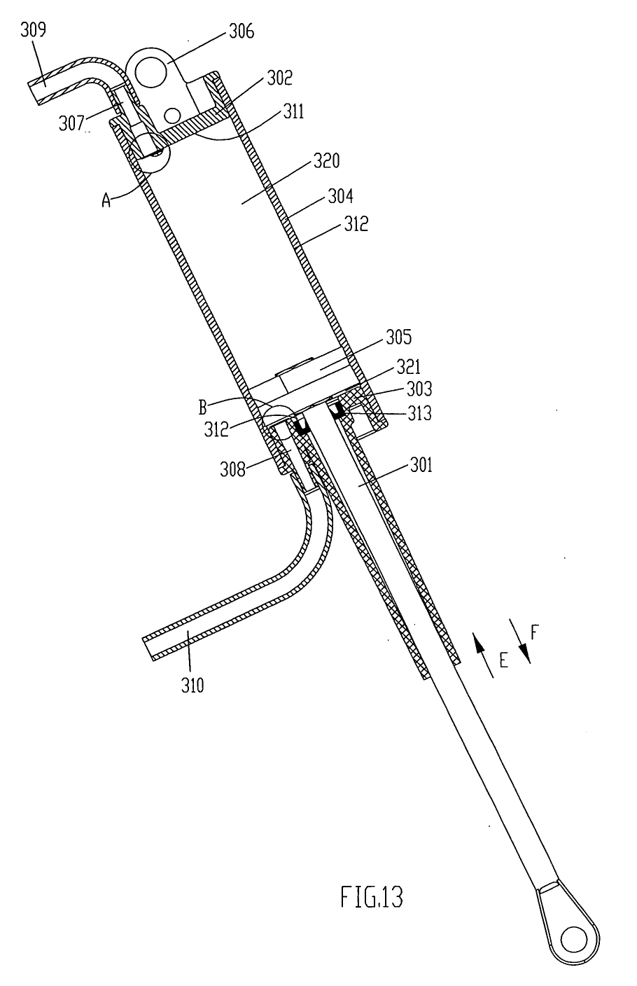

As shown in FIG. 13, the damper device 300 includes a cylinder 304 defining a compression chamber, a piston 305 to rectilinearly reciprocate in the compression chamber to compress air, a shaft 301 interconnected with the piston 305 and a connecting member 306. A first cap 302 and a second cap 303 are disposed on respective ends of the cylinder 304. The cylinder 304 is pivotally connected to the second elongate link arm 62 by the connecting member 306 (as shown in FIG. 2). The shaft 301 passes the second cap 303 and is pivotally connected to the first elongate link arm 61 (as shown in FIG. 2). A hermetic ring 313 is disposed between the shaft 301 and the second cap 303 for preventing the escape of air.

The cylinder 304 has a generally cylindrical inner wall 312. A diameter of the piston 305 is greater than the diameter of the inner wall 312. The piston 305 is typically made of rubber. Thus the piston 305 rectilinearly reciprocates along the inner wall 312 of the cylinder 304. At the same time, the piston 305 tightly adheres to the inner wall 312 for preventing the escape of air.

A first hermetic chamber 320 is composed of the inner wall 312 of the cylinder 304, the first cap 302 and upper surface of the piston 305. A second hermetic chamber 321 is composed of the inner wall 312 of the cylinder 304, the second cap 303 and the lower surface of the piston 305.

The first and the second caps 302 and 303 have a first and second air hole 307 and 308 respectively. The first air hole 307 is formed on the first cap 302 to connect the first hermetic chamber 320 to the outside of the cylinder 304. The second air hole 308 is formed on the second cap 303 to connect the second hermetic chamber 321 to the outside of the cylinder 304.

The damper device 300 further includes a first windpipe 309 connected to the first hole air 307 and a second windpipe 310 connected to the second hole air 308. The first and the second windpipes 309 and 310 are flexible tubes to be bent as required and are received in a gap in the second elongate link arm 62 or the first elongate link arm 61. The first and the second windpipes 309 and 310 are able to act as either an air outlet or an air inlet.

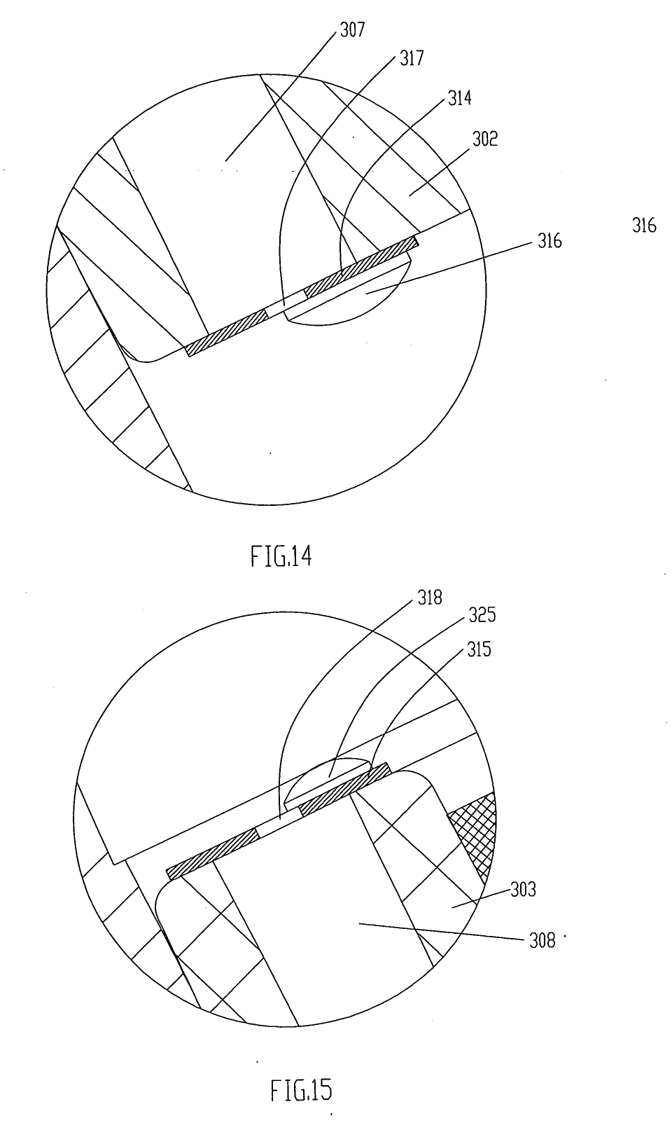

As shown in FIGS. 14 and 15, an elastic piece 314 is pivotally attached to the first cap 302 by a screw 316. Similarly, an elastic piece 315 is pivotally attached to the second cap 303 by a screw 325. The elastic piece 314 has a third air hole 317 located correspondingly to the first air hole 307. The elastic piece 315 has a fourth air hole 318 located correspondingly to the second air hole 308. The diameter of the first air hole 307 is greater than that of the third air hole 317. The diameter of the second air hole 308 is greater than that of the fourth air hole 318.

As shown in FIG. 13, when the piston 305 is slid upwardly along with the shaft 301 in direction E, the piston 305 compresses air in the first hermetic chamber 320 which causes the air to discharge from the third air hole 317 through the first air hole 307 and the first windpipe 309 to the outside of the cylinder 304 for reducing the impact force. At this time, the first windpipe 309 functions as an air outlet. When the piston 305 is slidable upwardly in direction E, the pressure of the second hermetic chamber 321 is decreased which causes external air to enter into the second windpipe 310. The elastic piece 315 is pivotal around the screw 325 to create a gap between the elastic piece 315 and the second cap 303. Thus the outside air can pass through the second windpipe 310 and enter into the second hermetic chamber 321. At this time, the second windpipe 310 functions as an air inlet.

Contrarily when the piston 305 is slid downwardly along with the shaft 301 in direction F, the piston 305 compresses air in the second hermetic chamber 321 which causes the air to discharge from the fourth air hole 318 through the second air hole 308 and the second windpipe 310 to the outside of the cylinder 304 for reducing the impact force. At this time, the first second windpipe 310 functions as an air outlet. When the piston 305 is slid downwardly in direction F, the pressure of the first hermetic chamber 320 is decreased which causes outside air to enter into the first windpipe 309. The elastic piece 314 is pivotal around the screw 316 to create a gap between the elastic piece 314 and the first cap 302. Thus the outside air can pass through the first windpipe 309 and enter into the first hermetic chamber 320. At this time, the first windpipe 309 functions as an air inlet.

As shown in FIG. 1, the miter saw of this invention is equipped with a laser indication device 400. The laser indication device 400 is mounted on the first elongate link arm 61 for aligning a laser beam with a cutting line marker marked on one side of a workpiece.

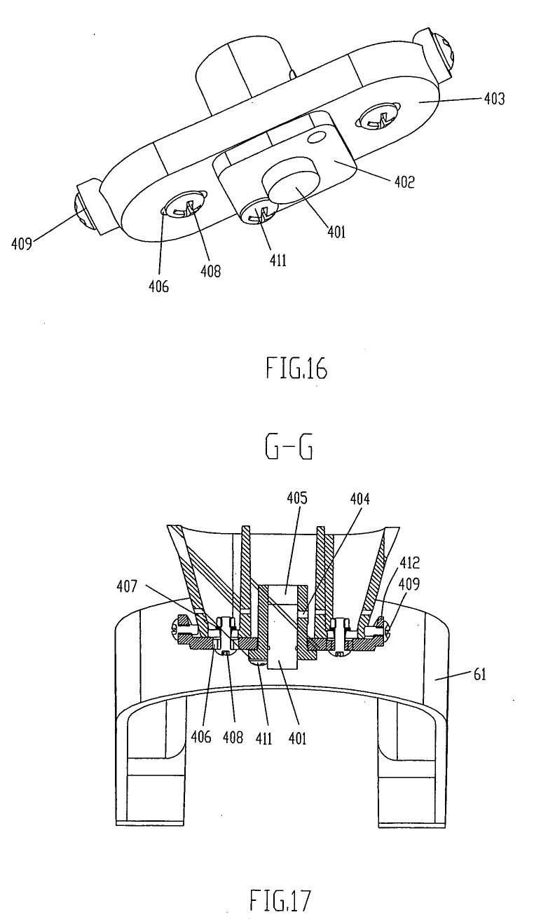

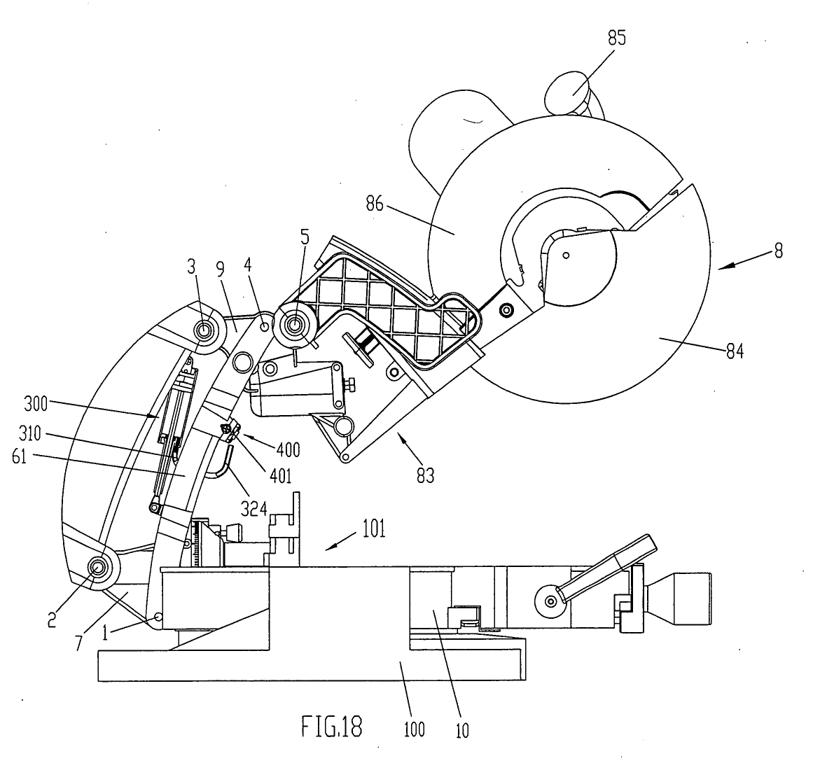

As shown in FIGS. 16 and 17, the laser indication device 400 includes a laser generator 401 extending in a longitudinal direction, a laser seat 402 for supporting the laser generator 401 and a support seat 403 attached to the first elongate link arm 61 for supporting the laser seat 402. The laser seat 402 is attached to the support seat 403 by a bolt 411.

The laser seat 402 is formed with a circular channel 405 for receiving the laser generator 401. A ring (not labeled) is disposed in the circular channel 405. The laser generator 401 rotates in a radial direction but does not slide in the longitudinal direction. The laser seat 402 is formed with a throughhole 404. A bolt (not shown) extends through the throughhole 404 to be screwed and locked in the laser generator 401 so that the laser generator 401 can not rotate in the longitudinal direction.

The support seat 403 is formed with a pair of elongated holes 406. The first elongate link arm 61 is formed with a pair of corresponding throughholes 407. A pair of bolts 408 co-operate with a washer (not labeled) to extend through respective elongated holes 406 and throughholes 407 to be screwed and locked in the nut (not labeled). Thus the support seat 403 is secured to the first elongate link arm 61.

Each end of the support seat 403 has a throughhole 412. An adjusting bolt 409 passes through the throughhole 412 to be screwed and locked to the first elongate link arm 61.

In use, the laser generator 401 projects a beam of light onto a workpiece (not shown) placed on the turntable 10. Because the laser generator 401 is opposite to the circumference of the saw blade 81, the position projected by the laser generator 401 is exactly the position of the workpiece to be cut by the saw blade 81. Thus, the operator may easily and clearly inspect whether there is a deflection between the cutting position of the saw blade 81 and the position of the workpiece thereby adjusting the position of the workpiece accordingly.

Typically vibrations will be produced during the cutting process which may result in the support seat 403 slipping and causing misalignment of the position indicated by the laser generator 401 and the cutting position of the saw blade 81. Referring to FIG. 17, the operator unscrews the bolt 408 that is locked on the support seat 403 and the first elongate link arm 61 and then rotates the adjusting bolt 409 to adjust the position of the support seat 403. The bolts 408 are then screwed and tightened to reposition the support seat 403.

The laser generator 401 may project a linear indication light. The indication light should align with the elongated slit (not shown) of the turntable 10. The vibrations produced during the cutting process may cause the laser generator 401 to deflect which may result in a tilt angle formed between the indication light projected by the laser generator 401 and the elongate slit of the turntable 10. At this time, the operator unscrews the bolt that is locked on the laser generator 401 and laser seat 402 and then rotates the laser generator 401 so that the indication light is realigned with the elongate slit of the turntable 10.

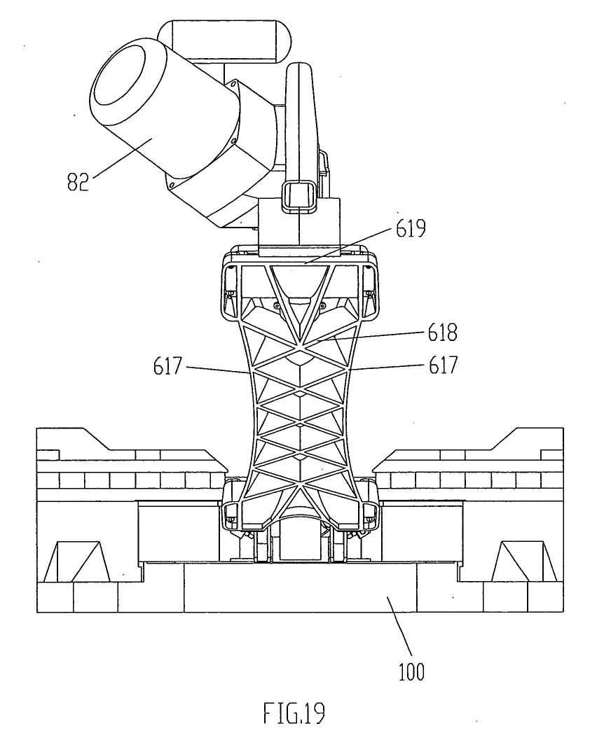

During cutting, sawdust flies towards the laser generator 401. To remove sawdust that clings to the laser generator 401, a cleaning mechanism is provided. In the present embodiment the cleaning mechanism is the first and second windpipes 309 and 310 which are flexible tubes and constitute air outlets. Referring to FIG. 18, the second windpipe 310 extends through the first elongate link arm 61 to be opposite the laser generator 401. Thus the second windpipe 310 operating as an air outlet can remove any sawdust that clings to the laser generator 401. Similarly the first windpipe 309 can extend through the first elongate link arm 61 to discharge air to remove sawdust.

When in use, the operator may initially adjust the position of the workpiece to make the linear indication light from the laser generator 401 align with the cutting position on the workpiece. By pulling the handle 85 (see FIG. 2), the first and second elongate link arms 61 and 62 are rotated around the first horizontal shaft 1 and second horizontal shaft 2 in a clockwise direction respectively. The saw unit 8 and the second support mechanism 9 are moved away from the fence 101. During extension of the saw unit 8 away from the fence 101, the piston 305 is slidable upwardly along with the shaft 301 in the direction E. The piston 305 compresses air in the first hermetic chamber 320 which causes air to discharge from the third air hole 317 through the first air hole 307 and the first windpipe 309 to the outside of the cylinder 304 for reducing the impact force (as shown in FIG. 13).

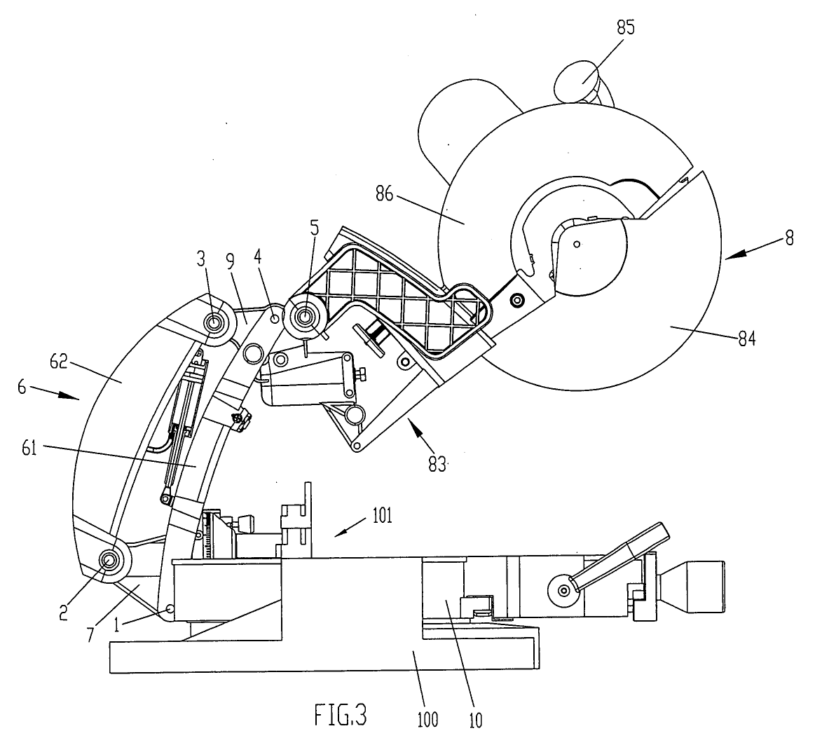

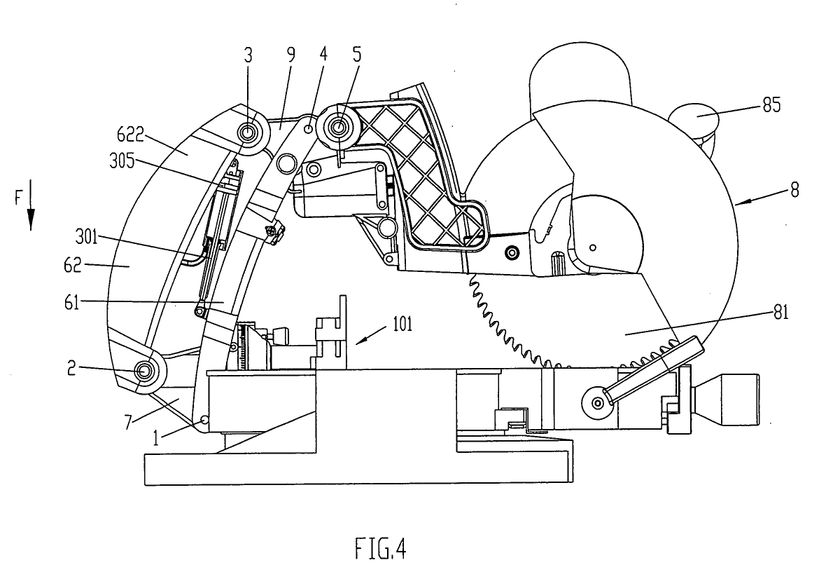

By pulling the handle 85 to the cutting position shown in FIG. 3, the operator then depresses the handle 85 so that the saw unit 8 is rotated around the fifth horizontal shaft 5 to a position where the saw blade 81 is flexed into the cutting position to contact the workpiece. In the mean time, the safety cover 84 is pivotal to uncover the exposed operational portion of the saw blade 81. The operator then pushes the handle 85 to rotate the second elongate link arm 62 to rotate around the second shaft 2 in a counter-clockwise direction. Thus, as show in FIG. 5, the saw blade 81 is moved toward the fence 101 and can cut the workpiece.

During movement of the saw unit 8 toward the fence 101, the piston 305 is slidable downwardly along the shaft 301 in direction F and the piston 305 compresses air in the second hermetic chamber 321 which causes air to discharge from the fourth air hole 318 for reducing the impact force. The first windpipe 309 functions as an air outlet. Furthermore, referring to FIG. 18, the second windpipe 310 is disposed in and extends through the first elongate link arm 61 to be opposite the laser generator 401. Thus the air from the second windpipe 310 can remove any sawdust that clings to the laser generator 401. After the saw blade 81 cuts the workpiece, the saw unit 8 is pivoted and returned to its resting position (as shown in FIG. 2) by the compression spring.

The miter saw may perform differently. As shown in FIG. 2, a locking pin 613 is attached to the first elongate link arm 61. A locking hole 93 is formed on the second support mechanism 9 for receiving the locking pin 613. The first elongate link arm 61 is fixed to the second support mechanism 9 when the locking pin 613 is received in the locking hole 93. Thus the first and second elongate link arm 61 and 62 can not rotate around the first and second horizontal shafts 2 and 3 respectively. The saw unit 8 can only rotate around the fifth horizontal shaft 5.

A positioning pin 92 is attached to the second support mechanism 9 (see FIG. 2). A positioning hole 88 is formed on the saw unit 8 for receiving the positioning pin 92. The saw unit 8 is fixed to the second support mechanism 9 when the positioning pin 92 is received in the positioning hole 88. This reduces the packing volume of the miter saw and makes it easily transported very conveniently.

1. A power tool comprising:
a cutting table for supporting a cuttable workpiece, wherein the cutting table is in a working plane;
a cutting unit including a cutting tool, wherein the cutting unit is rotational about a bevel axis whereby to adjust the cutting tool from a first plane relative to the working plane defining a first bevel angle to a second plane relative to the working plane defining a second bevel angle, wherein the cutting unit is pivotal from an elevated non-cutting position remote from the cutting table to a non-elevated cutting position at or near to the cutting table and from the non-elevated cutting position at or near to the cutting table to the elevated non-cutting position remote from the cutting table;
an elongate coupling assembly operatively coupling the cutting unit to the cutting table which is adapted to rotate the cutting unit about the bevel axis to adjust the cutting tool from the first plane to the second plane and to pivot the cutting unit from the elevated non-cutting position to the non-elevated cutting position;
a stationary member fixed to the cutting table;
a tiltable member fixed to the elongate cutting assembly so as to be pivotal relative to the stationary member in response to the rotation of the cutting unit about the bevel axis; and
an angle enlarging mechanism disposed between the stationary member and the tiltable member, wherein the angle enlarging mechanism includes:
a fixed gear fixed to one of the stationary member and the tiltable member;
a transmission assembly disposed on the other of the stationary member and the tiltable member;
a rotary gear having internal teeth, wherein the rotary gear is movably supported on the one or the other of the stationary member and the tiltable member, wherein the transmission assembly includes a first gear for meshing with the fixed gear and a second gear for meshing with the internal teeth of the rotary gear; and
an indicator assembly including an indicator for indicating the bevel angle disposed immovably on one of the rotary gear and the stationary member.

2. The power tool according to claim 1, wherein the bevel axis is substantially radial to the cutting table.

3. The power tool according to claim 1, wherein the bevel axis is substantially horizontal.

4. The power tool according to claim 1, wherein the axis of the transmission assembly is non-coincident with the bevel axis so as to rotate the rotary gear when the tiltable member pivots relative to the stationary member.

5. The power tool according to claim 1, wherein when the tiltable member pivots relative to the stationary member, the transmission assembly is actuated around the bevel axis so as to cause the first gear to rotate the fixed gear and the second gear to rotate the rotary gear.

6. The power tool according to claim 1, wherein when the tiltable member pivots relative to the stationary member, the fixed gear is actuated around the bevel axis to rotate the first gear and to cause the second gear to rotate the rotary gear.

7. The power tool according to claim 1, wherein the indicator assembly further comprises a scale disposed immovably on the other of the rotary gear and the stationary member.

8. The power tool according to claim 1, wherein the first gear is fixed to or integral with the second gear.

9. The power tool according to claim 8, wherein in use the first gear turns the fixed gear in an opposite rotating direction and the second gear turns the rotary gear in a same rotating direction.

10. The power tool according to claim 8, wherein the transmission assembly further comprises a short shaft, wherein the first gear and the second gear are rotatably mounted on the short shaft.

11. The power tool according to claim 10, wherein the short shaft is fixed to the one or the other of the stationary member and the tiltable member.

12. The power tool according to claim 1, wherein the fixed gear is fixed to the tiltable member, the transmission assembly is fixed to the stationary member and the rotary gear is movably supported on the stationary member.

13. The power tool according to claim 12, wherein in use the rotational direction of the rotary gear differs from the rotational direction of the tiltable member.

14. The power tool according to claim 1, wherein the fixed gear is fixed to the stationary member, the transmission assembly is fixed to the tiltable member and the rotary gear is movably supported on the tiltable member.

15. The power tool according to claim 14, wherein in use the rotational direction of the rotary gear and the rotational direction of the tiltable member are the same.

16. The power tool according to claim 1, wherein the diameter of the rotary gear is greater than the diameter of the second gear.

17. The power tool according to claim 1, wherein the diameter of the fixed gear is greater than the diameter of the first gear.

18. The power tool according to claim 1, wherein the diameter of the second gear is greater than the diameter of the first gear.

19. The power tool according to claim 1 being a miter saw which comprises:
a base, wherein the cutting table is a turntable pivotally mounted on the base,
wherein the cutting unit includes a motor and the cutting tool is a rotary saw blade driven by the motor,
wherein the elongate coupling assembly comprises:
a first support mechanism mounted on the turntable rotationally about the substantially radial bevel axis;
a second support mechanism, wherein the cutting unit is pivotally mounted on the second support mechanism for flexion of the rotary saw blade from the elevated non-cutting position to the non-elevated cutting position and extension of the rotary saw blade from the non-elevated cutting position to the elevated non-cutting position; and
an elongate linkage arrangement linking the first support mechanism to the second support mechanism,
wherein the tiltable member is fixed to the first support mechanism.

20. The power tool according to claim 19, wherein the elongate linkage arrangement includes a first elongate link arm pivotally disposed between the first support mechanism and the second support mechanism and a second elongate linkage arm pivotally disposed between the first support mechanism and the second support mechanism.

21. A power tool comprising:
a stationary member;
a tiltable member pivotally mounted on the stationary member about a horizontal axis;
an angle enlarging mechanism disposed between the stationary member and the tiltable member, the angle enlarging mechanism comprising:
a fixed gear fixedly disposed on one of the stationary member and the tiltable member;
a transmission assembly disposed on the other of the stationary member and the tiltable member;
a rotatable gear having internal teeth, the rotatable gear movably supported on one of the stationary member and the tiltable member;
wherein the transmission assembly includes a first gear for meshing with the fixed gear and a second gear for meshing with the internal teeth of the rotary gear; and
an indicator assembly comprising an indicator disposed immovably with one of the rotatable gear and the stationary member.
